(19) United States
(12) Patent Application Publication
(10) Pub. No.: US 2026/0231897 A1
(43) Pub. Date: Aug. 13, 2026

(54) CAT LITTER BOX

(71) Applicant: Shenzhen Petsuper Smart Technology Co., Ltd., Shenzhen (CN)

(72) Inventors: Kaiyang Hu, Shenzhen (CN); Jingli Wei, Shenzhen (CN)

(21) Appl. No.: 19/263,533

(22) Filed: Jul. 9, 2025

(30) Foreign Application Priority Data
Feb. 10, 2025 (CN) 202510144188.5

(51) Int. Cl. A01K 1/01

(52) U.S. Cl. CPC A01K 1/011

(57) ABSTRACT

Provided is cat litter box, wherein the cat litter box includes a base, a roller component and a packaging device. The feces collecting bin is used to place the sealing bag. The roller component is installed in the first mounting groove, and the roller component rotates relative to the base. A litter-separating member is provided in the interior of the roller component, one side of the roller component close to the feces collecting bin is provided with a first opening, and the litter-separating member extends to the position of the first opening. The roller component is communicated with the feces collecting bin through the first opening. The packaging device is arranged corresponding to the feces collecting bin. The heating member is connected to the cutting member, the sealing component moves relative to the cutting member, and the sealing component can abut against or move away from the cutting member.

### CROSS-REFERENCE TO RELATED APPLICATION

The present disclosure claims priority to Chinese patent application No. 202510144188.5, filed with the Chinese Patent Office on Feb. 10, 2025, the entire contents of which are incorporated herein by reference.

### TECHNICAL FIELD

The present disclosure relates to the technical field of pet products, and in particular to a cat litter box.

### BACKGROUND ART

A cat litter box is used as a pet toilet product to facilitate the cleaning of pet excrement. Pet excrement in the cat litter box needs to be collected with sealing bags to ensure a clean, hygienic, and sustainably usable environment inside the cat litter box. At present, the sealing bags of the cat litter box require users to manually tear them for disposal, making it inconvenient to use and resulting in a poor user experience.

### SUMMARY

The present disclosure aims to provide a cat litter box, and the sealing component drives the sealing bag to abut against the cutting member to automatically cut off the connection part of the sealing bag, thereby improving the cutting efficiency of the sealing bag, reducing the situation that users need to tear the sealing bag manually, and being beneficial to cleaning the pet feces clumps, so as to improve the user experience.

In the first aspect of the present disclosure, a cat litter box is provided, including:
a base, wherein the base is provided with a first mounting groove and a feces collecting bin, and the feces collecting bin is used to place a sealing bag;
a roller component, wherein the roller component is installed in the first mounting groove and the roller component rotates relative to the base, wherein a litter-separating member is provided in the interior of the roller component, one side of the roller component close to the feces collecting bin is provided with a first opening, and the litter-separating member extends to the position of the first opening; and the roller component is communicated with the feces collecting bin through the first opening, and
a packaging device, wherein the packaging device is arranged corresponding to the feces collecting bin, wherein the packaging device includes a sealing component and a cutting component; the cutting component includes a heating member and a cutting member, with the heating member connected to the cutting member; and the sealing component moves relative to the cutting member, and the sealing component can abut against or move away from the cutting member.

In a possible example of the present disclosure, the sealing component includes a driving member, a movable member and a transmission screw, wherein the driving member is in transmission connection with the transmission screw, and the movable member is movably connected with the transmission screw. The driving member drives the movable member to move relatively in a first direction through the transmission screw.

In a possible example of the present disclosure, the sealing component further includes a guide rail member, one end of the movable member is movably connected with the transmission screw, and one end of the movable member far away from the transmission screw is connected with the guide rail member. The guide rail member is arranged in parallel with the transmission screw.

In a possible example of the present disclosure, the sealing component further includes a first microswitch and a second microswitch, and the movable member has a first position and a second position; the first microswitch is arranged at the first position, and the second microswitch is arranged at the second position.

When the movable member is at the first position, the movable member abuts against the cutting member, and the movable member abuts against the first microswitch.

When the movable member is at the second position, the movable member is far away from the cutting member, and the movable member abuts against the second microswitch.

In a possible example of the present disclosure, the cutting component includes a box body, wherein the box body is provided with an accommodating groove; the heating member is arranged in the accommodating groove; the cutting member contacts with the heating member, and the cutting member closes the notch of the accommodating groove. The side of the cutting member facing away from the heating member is provided with a blade part, and the blade part corresponds to the movable member.

In a possible example of the present disclosure, the cat litter box further includes a cover plate member, the feces collecting bin is provided with a second opening, and the cover plate member is covered on the second opening. The cover plate member is movably connected with the feces collecting bin.

In a possible example of the present disclosure, the center line direction of the second opening and the center line direction of the first opening are perpendicular to each other.

In a possible example of the present disclosure, an air outlet and an aeration member are arranged in the feces collecting bin, wherein the aeration member is arranged at the air outlet, and the aeration member can create a negative pressure space within the feces collecting bin.

In a possible example of the present disclosure, the cat litter box further includes a control member and a first sensing member, wherein the first sensing member is arranged at the bottom of the feces collecting bin, and the control member is electrically connected with the first sensing member.

In a possible example of the present disclosure, the cat litter box further includes a litter adding device. One end of the roller component far away from the packaging device is provided with a third opening, and the base is provided with a second mounting groove; the litter adding device is inserted into the second mounting groove, and the litter adding device extends into the roller component through the third opening.

Compared with the prior art, the beneficial effects of the present disclosure are as follows: the roller component of the cat litter box provided by the present disclosure can separate the pet feces clumps from the cat litter by the litter-separating member during the rotation process, the pet feces clumps are transmitted to the feces collecting bin through the first opening, so that the pet feces clumps directly fall into the sealing bag of the feces collecting bin. After the pet feces clumps are collected by the sealing bag, it can move towards the cutting member through the sealing component, the sealing component is used to tighten the sealing bag. As the sealing bag has a roll-type structure, the heating member heats the cutting member to raise the temperature of the cutting member, and the sealing component drives the sealing bag to abut against the cutting member to automatically cut off the connection part of the sealing bag, so that the cutting member has a certain fusing effect on the sealing bag, thereby improving the cutting efficiency of the sealing bag, reducing the situation that users need to tear the sealing bag by hand, so as to facilitate the cleaning the pet feces clumps and improve the user experience.

### BRIEF DESCRIPTION OF THE DRAWINGS

In order to more clearly illustrate the technical solutions of examples in the present disclosure, the drawing to be used in examples will be briefly introduced below. It should be understood that the following drawing only shows some examples of the present disclosure, so they should not be regarded as limiting the scope, for a person of ordinary skill in the art, other drawings can be obtained according to the drawing without inventive efforts.

FIG. 1 is a first schematic diagram of the three-dimensional structure of a cat litter box provided in some examples of the present disclosure.

FIG. 2 is a schematic diagram of the three-dimensional assembly of a cat litter box provided in some examples of the present disclosure.

FIG. 3 is a second schematic diagram of the three-dimensional structure of a cat litter box provided in some examples of the present disclosure.

FIG. 4 is a first cross-sectional schematic diagram of a cat litter box provided in some examples of the present disclosure.

FIG. 5 is a second cross-sectional schematic diagram of a cat litter box provided in some examples of the present disclosure.

FIG. 6 is a first structural schematic diagram of a packaging device for a cat litter box provided in some examples of the present disclosure.

FIG. 7 is a second structural schematic diagram of a packaging device for a cat litter box provided in some examples of the present disclosure.

FIG. 8 is a structural schematic diagram of a cutting component of a cat litter box provided in some examples of the present disclosure.

Reference signs of main components:
100—cat litter box; 110—base; 111—feces collecting bin; 1111—second opening; 1112—cover plate member; 1113—aeration member; 112—first mounting groove; 113—second mounting groove; 120—roller component; 121—litter—separating member; 122—first opening; 123—third opening; 130—packaging device; 131—sealing component; 1311—driving member; 1312—movable member; 1312a—connecting wheel; 1313—transmission screw; 1314—guide rail member; 1314a—first guide rail member; 1314b—second guide rail member; 1315—first microswitch; 1316—second microswitch; 132—cutting component; 1321—heating member; 1322—cutting member; 1322a—blade part; 1323—box body; 140—litter adding device; 200—sealing bag; X-first direction; Y-second direction.

### DETAILED DESCRIPTION OF EMBODIMENTS

In order to make the objectives, technical solutions and advantages of the examples of the present disclosure clearer, the technical solution in the example of the present disclosure will be described clearly and completely with the attached drawings. Obviously, the described example is a part of the example of the present disclosure, but not the whole example. The components of the examples of the present disclosure, which are described and illustrated in the drawings herein, can generally be arranged and designed in various configurations.

Therefore, the following detailed description of the examples of the present disclosure provided in the drawings is not intended to limit the scope claimed in the present disclosure but only represents selected examples of the present disclosure. Based on the examples in the present disclosure, all other examples obtained by ordinary technicians in the field without inventive work belong to the protection scope of the present disclosure.

It should be noted that similar symbols and letters indicate similar items in the following drawings, so once an item is defined in one drawing, it does not need to be further defined and explained in subsequent drawings.

In the description of the present disclosure, it should be noted that the terms “center”, “upper”, “lower”, “left”, “right”, “vertical”, “horizontal”, “inside” and “outside” and the like indicate orientations or positional relationships based on those shown in the accompanying drawings, or the orientations or positional relationship that the product of the present disclosure is usually placed in use. They are intended only for the purpose of facilitating the description of the present disclosure and to simplify the description and are not indicative of, or suggestive of, that the referred device or components must have a particular orientation, be constructed and operated with a particular orientation, and therefore are not to be understood as limitations of the present disclosure. Furthermore, the terms such as “first”, “second” and “third” are configured to distinguish descriptions only and are not to be understood as indicating or implying relative importance.

In addition, the terms such as “horizontal”, “vertical” and “overhanging” do not mean that the parts are required to be absolutely horizontal or overhanging, but may be slightly inclined. For example, “horizontal” only means that its direction is more horizontal than “vertical” and does not mean that the structure must be perfectly horizontal, but may be slightly inclined.

In the description of the present disclosure, it should also be noted that the terms “provide”, “mount”, “joint” and “connect” should be broadly understood, for example, they can be fixed connection, detachable connection, or integrated connection; it can be a mechanical connection or an electrical connection; it can be directly connected, or be indirectly connected through an intermediate medium, further can be connected inside two elements. For those skilled in the art, the specific meanings of the above terms in the present disclosure can be understood in specific circumstances.

Some embodiments of the present disclosure are described in detail below with reference to the drawings. In the case of no conflict, the following examples and features in the examples can be combined with each other.

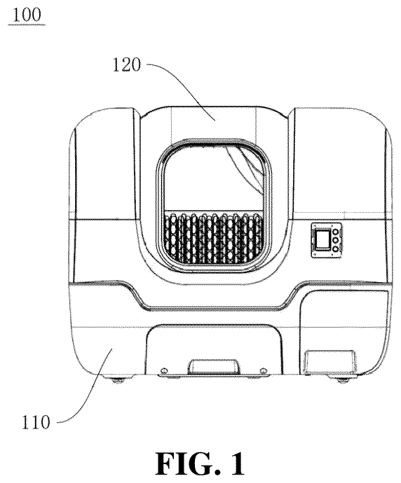

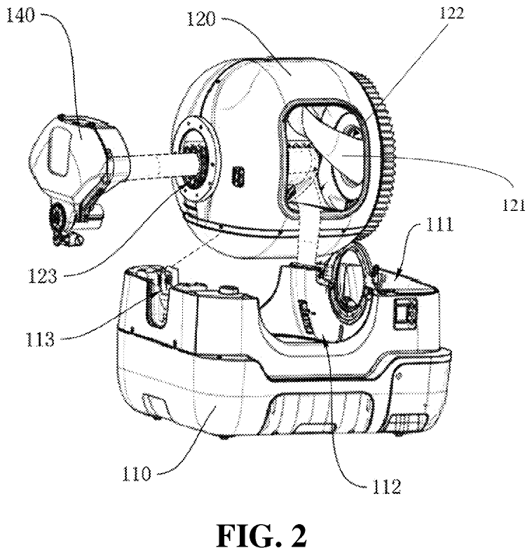

Referring to FIG. 1 and FIG. 2, a cat litter box 100 is provided in an example of the present disclosure, including a base 110, a roller component 120 and a packaging device 130.

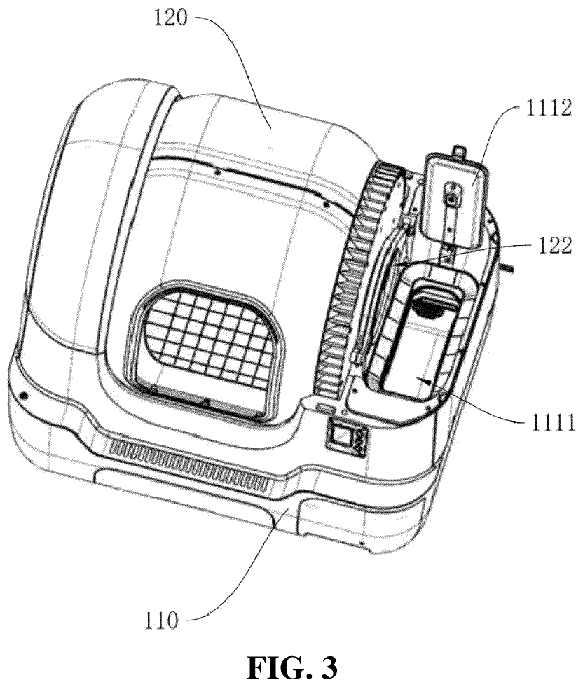

Specifically, as shown in FIG. 2 and FIG. 3, the base 110 is provided with a first mounting groove 112 and a feces collecting bin 111, and the feces collecting bin 111 is used to place the sealing bag 200. The roller component 120 is installed in the first mounting groove 112, and the roller component 120 rotates relative to the base 110. The interior of the roller component 120 is provided with a litter-separating member 121, one side of the roller component 120 close to the feces collecting bin 111 is provided with a first opening 122, and the litter-separating member 121 extends to the position of the first opening 122. The roller component 120 communicates with the feces collecting bin 111 through the first opening 122. During the rotating process, the roller component 120 can separate the pet feces clumps from the cat litter through the litter-separating member 121, and the pet feces clumps are transmitted to the feces collecting bin 111 through the first opening 122, so that the pet feces clumps directly fall into the sealing bag 200 of the feces collecting bin 111.

In the present example, the packaging device 130 is arranged corresponding to the feces collecting bin 111, wherein the packaging device 130 includes a sealing component 131 and a cutting component 132. The cutting component 132 includes a heating member 1321 and a cutting member 1322. The heating member 1321 is connected with the cutting member 1322, and the sealing component 131 moves relative to the cutting member 1322. The sealing component 131 can abut against or be far away from the cutting member 1322, and correspondingly, after the pet feces clumps are collected by the sealing bag 200, it can move towards the cutting member 1322 through the sealing component 131. The sealing component 131 is used to tighten the sealing bag 200. Since the sealing bag 200 is of a roll-type structure, the heating member 1321 heats the cutting member 1322 to raise the temperature of the cutting member 1322, and the sealing component 131 drives the sealing bag 200 to abut against the cutting member 1322 to automatically cut off the connection part of the sealing bag 200, so that the cutting member 1322 has a certain fusing effect on the sealing bag 200, thereby improving the cutting efficiency of the sealing bag 200, reducing the situation that users need to tear the sealing bag 200 by hand, so as to facilitate the cleaning the pet feces clumps.

Exemplary, as shown in FIG. 3, the height of the first opening 122 of the roller component 120 is higher than that of the feces collecting bin 111, so that the pet feces clumps can fall through the first opening 122 of the roller component 120 into the sealing bag 200 of the feces collecting bin 111 for collection.

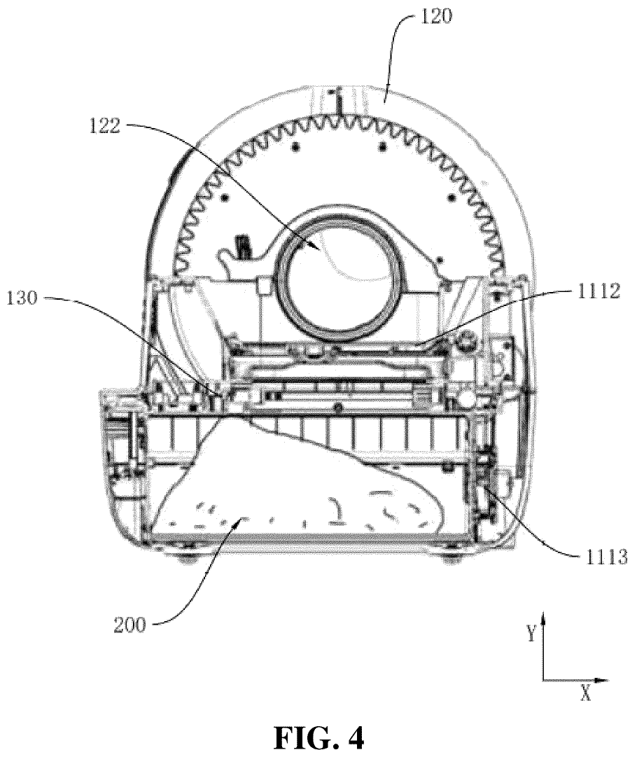

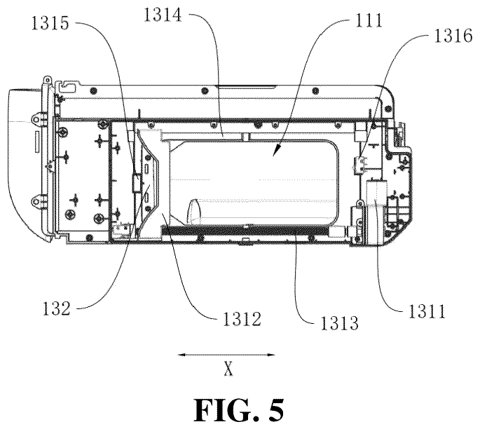

It should be noted that, referring to FIG. 4 and FIG. 5, the cat litter box 100 has a first direction X and a second direction Y, wherein the first direction X and the second direction Y are vertically arranged. Illustratively, the first direction X takes the length direction of the cat litter box 100 as an example, and the second direction Y takes the height direction of the cat litter box 100 as an example. It can be understood that the above definition is only for the convenience of understanding the relative position relationship of various parts in the cat litter box 100, and it should not be understood as a limitation of the present disclosure.

In an example, optionally, referring to FIG. 5, the sealing component 131 includes a driving member 1311, a movable member 1312 and a transmission screw 1313, wherein the driving member 1311 is in transmission connection with the transmission screw 1313, and the movable member 1312 is in movable connection with the transmission screw 1313. The driving member 1311 drives the movable member 1312 to move relatively along the first direction X through the transmission screw 1313. In other words, the transmission screw 1313 passes through the movable member 1312, and the driving member 1311 drives the transmission screw 1313 to rotate, so that the transmission screw 1313 moves relatively to the movable member 1312, making the movable member 1312 relatively move along the length direction of the cat litter box 100. The movable member 1312 abuts against the cutting member 1322 to achieve the purpose of cutting off the sealing bag 200, or the movable member 1312 can be separated from the cutting member 1322.

In an example, optionally, as shown in FIG. 3 and FIG. 4, the cat litter box 100 further includes a cover plate member 1112. The second opening 1111 is formed in the feces collecting bin 111, and the cover plate member 1112 is covered with the second opening 1111 and the cover plate member 1112 is movably connected with the feces collecting bin 111. The pet feces clumps in the roller component 120 can fall to the second opening 1111 of the feces collecting bin 111 through the first opening 122, making it convenient for the feces collecting bin 111 to collect the pet feces clumps. The cover plate member 1112 can open the second opening 1111 of the feces collecting bin 111, or the cover plate member 1112 can cover and close the second opening 1111 of the feces collecting bin 111, thus reducing the situation of odor escaping from the feces collecting bin 111, so as to improve the user experience.

In an example, optionally, referring to FIG. 1, the cat litter box 100 further includes a control member and a first sensing member, wherein the first sensing member is arranged at the bottom of the feces collecting bin 111, and the control member is electrically connected with the first sensing member. The first sensing member is used to detect the weight of the pet feces clumps, so that when the pet feces clumps reach a full level, the sealing component 131 is controlled to tighten and seal the sealing bag 200, and the connecting position of the sealing bag 200 is cut by the cutting component 132. Further, the roller component 120 is provided with a third sensing member, wherein the third sensing member is electrically connected with the control member, and the third sensing member is used to detect whether pets enter the roller component 120.

Illustratively, the control member is a controller, wherein the controller can include an integrated circuit chip with signal processing capability. The aforementioned controller can be a general-purpose processor, including a central processing unit (CPU), and can further be a single chip microcomputer, a micro-control unit (MCU), a complex programmable logic device (CPLD), a field programmable gate array (FPGA), an application specific integrated circuit (ASIC), an embedded ARM chips or other chips. The first sensing member can be a weight sensor, while the third sensing member can be an infrared sensor or other types of sensors, with no specific limitations imposed herein.

To sum up, the roller component 120 of the cat litter box 100 can separate the pet feces clumps from the cat litter box through the litter-separating member 121 during the rotation process, and the pet feces clumps are transmitted to the feces collecting bin 111 through the first opening 122, so that the pet feces clumps directly fall into the sealing bag 200 of the feces collecting bin 111. After the pet feces clumps are collected through the sealing bag 200, it can move towards the cutting member 1322 through the sealing component 131, and the sealing component 131 is used to tighten the sealing bag 200. As the sealing bag 200 has a roll-type structure, the heating member 1321 heats the cutting member 1322 to raise the temperature of the cutting member 1322, and the sealing component 131 drives the sealing bag 200 to abut against the cutting member 1322 to automatically cut off the connection part of the sealing bag 200, so that the cutting member 1322 has a certain fusing effect on the sealing bag 200, thereby improving the cutting efficiency of the sealing bag 200, reducing the situation that the user needs to tear the sealing bag 200 by hand, so as to facilitate the cleaning the pet feces clumps and improve the user experience.

Referring to FIG. 1 to FIG. 3, another cat litter box 100 is provided in an example of the present disclosure, including a base 110, a roller component 120 and a packaging device 130.

Specifically, as shown in FIG. 2 and FIG. 3, the base 110 is provided with a first mounting groove 112 and a feces collecting bin 111, and the feces collecting bin 111 is used to place the sealing bag 200. The roller component 120 is installed in the first mounting groove 112, and the roller component 120 rotates relative to the base 110. A litter-separating member 121 is provided in the interior of the roller component 120, one side of the roller component 120 close to the feces collecting bin 111 is provided with a first opening 122, and the litter-separating member 121 extends to the position of the first opening 122. The roller component 120 is communicated with the feces collecting bin 111 through the first opening 122. The packaging device 130 is arranged corresponding to the feces collecting bin 111, wherein the packaging device 130 includes a sealing component 131 and a cutting component 132. The cutting component 132 includes a heating member 1321 and a cutting member 1322. The heating member 1321 is connected with the cutting member 1322, and the sealing component 131 moves relative to the cutting member 1322. The sealing component 131 can abut against or be far away from the cutting member 1322. Correspondingly, the roller component 120 can separate the pet feces clumps from the cat litter through the litter-separating member 121 during the rotation, the pet feces clumps are transported to the feces collecting bin 111 through the first opening 122, so that the pet feces clumps directly fall into the sealing bag 200 of the feces collecting bin 111. After the pet feces clumps are collected by the sealing bag 200, it can move towards the cutting member 1322 through the sealing component 131. The sealing component 131 is used to tighten the sealing bag 200. Since the sealing bag 200 is of a roll-type structure, the heating member 1321 heats the cutting member 1322 to raise the temperature of the cutting member 1322, and the sealing component 131 drives the sealing bag 200 to abut against the cutting member 1322 to automatically cut off the connection part of the sealing bag 200, so that the cutting member 1322 has a certain fusing effect on the sealing bag 200, thereby improving the cutting efficiency of the sealing bag 200, reducing the situation that users need to tear the sealing bag 200 by hand, so as to facilitate the cleaning the pet feces clumps.

It should be noted that, referring to FIG. 4 and FIG. 5, the cat litter box 100 has a first direction X and a second direction Y, wherein the first direction X and the second direction Y are vertically arranged. Illustratively, the first direction X takes the length direction of the cat litter box 100 as an example, and the second direction Y takes the height direction of the cat litter box 100 as an example.

In an example, optionally, referring to FIG. 5, the sealing component 131 includes a driving member 1311, a movable member 1312 and a transmission screw 1313, wherein the driving member 1311 is in transmission connection with the transmission screw 1313, and the movable member 1312 is in movable connection with the transmission screw 1313. The driving member 1311 drives the movable member 1312 to move relatively along the first direction X through the transmission screw 1313. In other words, the transmission screw 1313 passes through the movable member 1312, and the driving member 1311 drives the transmission screw 1313 to rotate, so that the transmission screw 1313 moves relatively to the movable member 1312, and making the movable member 1312 relatively move along the length direction of the cat litter box 100. The movable member 1312 abuts against the cutting member 1322 to achieve the purpose of cutting off the sealing bag 200, or the movable member 1312 can be separated from the cutting member 1322. Illustratively, the driving member 1311 is a driving motor.

Optionally, referring to FIG. 5 to FIG. 7, the sealing component 131 further includes a guide rail member 1314, one end of the movable member 1312 is movably connected with the transmission screw 1313, and the end of the movable member 1312 which is far away from the transmission screw 1313 is connected with the guide rail member 1314. The guide rail member 1314 is arranged in parallel with the transmission screw 1313, and the opposite ends of the movable member 1312 are respectively connected with the transmission screw 1313 and the guide rail member 1314. Because the guide rail member 1314 and the transmission screw 1313 are parallel to each other, the transmission screw 1313 and the guide rail member 1314 jointly guide the relative movement of the movable member 1312, so as to avoid the deviation of the movable member 1312 during the movement, thus making the movable member 1312 move according to the preset path.

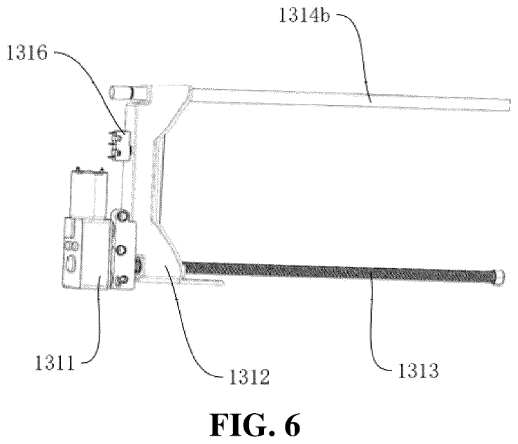

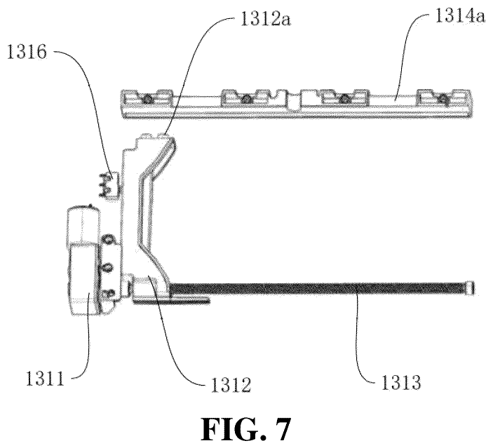

Further, as shown in FIG. 6, the guide rail member 1314 is a first guide rail member 1314a, wherein the first guide rail member 1314a is provided with a rail groove, and the movable member 1312 is provided with a connecting wheel 1312a, the connecting wheel 1312a is clamped into the rail groove of the first guide rail member 1314a. The movable member 1312 is slidably connected with the rail groove of the first guide rail member 1314a through the connecting wheel 1312a, enabling the movable member 1312 to move relative to the length direction of the cat litter box 100. As shown in FIG. 7, the guide rail member 1314 can further be a second guide rail member 1314b, wherein the second guide rail member 1314b is a guide rod, the movable member 1312 is sleeved over the guide rod, enabling the movable member 1312 to move relative to the guide rod along the length direction of the cat litter box 100.

Optionally, referring to FIG. 5, the sealing component 131 further includes a first microswitch 1315 and a second microswitch 1316, wherein the movable member 1312 has a first position and a second position, and the first microswitch 1315 is arranged at the first position and the second microswitch 1316 is arranged at the second position. It is understandable that microswitches are used to detect mechanical movement and convert it into an electrical signal. The first microswitch 1315 and the second microswitch 1316 are configured to trigger a detection signal, and whether the movable member 1312 is in its intended place can be determined by the detection signal, so that the automatic sealing operation of the sealing bag 200 can be realized. When the movable member 1312 is at the first position, the movable member 1312 abuts against the cutting member 1322, and the movable member 1312 abuts against the first microswitch 1315. The first position is the final position where the movable member 1312 tightens and seals the sealing bag 200. When the movable member 1312 is at the second position, the movable member 1312 is far away from the cutting member 1322, and the movable member 1312 abuts against the second microswitch 1316. The second position is the initial position of the movable member 1312 in an unused state, so that the movable member 1312 can move relatively between the initial position and the final position.

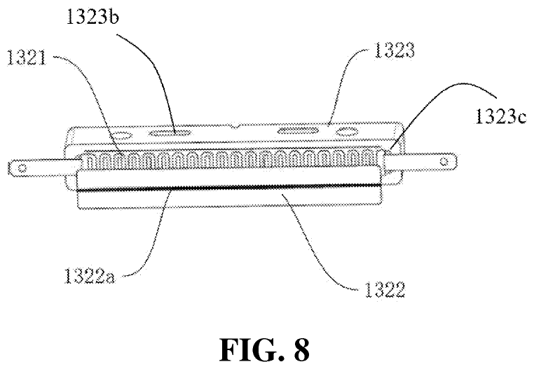

Optionally, referring to FIG. 5 and FIG. 8, the cutting component 132 includes a box body 1323, wherein the box body 1323 is provided with an accommodating groove, and the heating member 1321 is arranged in the accommodating groove. The cutting member 1322 contacts with the heating member 1321, and the cutting member 1322 closes the notch of the accommodating groove. The cutting member 1322 is provided with a blade part 1322a on the side facing away from the heating member 1321, and the blade part 1322a corresponds to the movable member 1312. Accordingly, the heating member 1321 is installed in the accommodating groove, and the box body 1323 plays a protective role to avoid the situation that the excessive temperature of the heating member 1321 will affect other parts. The heating member 1321 contacts the cutting member 1322 and heats the cutting member 1322, so that the blade part 1322a of the cutting member 1322 can directly fuse the cutting position when cutting the sealing bag 200, so as to improve the cutting efficiency.

In an example, optionally, as shown in FIG. 3 and FIG. 4, the cat litter box 100 further includes a cover plate member 1112. The second opening 1111 is formed in the feces collecting bin 111, and the cover plate member 1112 is covered with the second opening 1111 and the cover plate member 1112 is movably connected with the feces collecting bin 111. The pet feces clumps in the roller component 120 can fall to the second opening 1111 of the feces collecting bin 111 through the first opening 122, making it convenient for the feces collecting bin 111 to collect the pet feces clumps. The cover plate member 1112 can open the second opening 1111 of the feces collecting bin 111, or the cover plate member 1112 can cover and close the second opening 1111 of the feces collecting bin 111, thus reducing the situation of odor escaping from the feces collecting bin 111, so as to improve the user experience. Further, the cover plate member 1112 is hinged with the second opening 1111 of the feces collecting bin 111. Illustratively, the cover plate member 1112 is provided with a second sensing member, wherein the second sensing member can detect the state and the position of the cover plate member 1112. The control member can control the movement of the cover plate member 1112 through the second sensing member to open the second opening 1111 of the feces collecting bin 111, or close the second opening 1111 of the feces collecting bin 111.

Optionally, as shown in FIG. 3, the center line direction of the second opening 1111 and the center line direction of the first opening 122 are perpendicular to each other, in other words, the opening direction of the second opening 1111 and the opening direction of the first opening 122 are perpendicular to each other and in different directions. Illustratively, the height of the second opening 1111 is greater than that of the first opening 122, and the pet feces clumps drop to the position of the first opening 122 through the second opening 1111, making the pet feces clumps enter the feces collecting bin 111 ultimately.

In an example, optionally, as shown in FIG. 4, the interior of the feces collecting bin 111 is provided with an air outlet and an aerator member 1113, wherein the aeration member 1113 is arranged at the air outlet, and the aeration member 1113 can create a negative pressure space within the feces collecting bin 111. The aeration member 1113 is used to control the opening and closing of the air outlet. Moreover, the aerator member 1113 can form a negative pressure space inside the feces collecting bin 111, enabling the sealing bag 200 to be adsorbed to the bottom of the feces collecting bin 111, so that the sealing bag 200 can be automatically unfolded to facilitate the collection of pet feces clumps, thus improving the coverage of the sealing bag 200, and reducing the likelihood of the pet feces clumps falling to the areas not covered by the sealing bag 200.

In an example, optionally, referring to FIG. 1, the cat litter box 100 further includes a control member and a first sensing member, wherein the first sensing member is arranged at the bottom of the feces collecting bin 111, and the control member is electrically connected with the first sensing member. The first sensing member is used to detect the weight of the pet feces clumps, so that when the pet feces clumps reach a full level, the sealing component 131 is controlled to tighten and seal the sealing bag 200, and the connecting position of the sealing bag 200 is cut by the cutting component 132. Further, the roller component 120 is provided with a third sensing member, wherein the third sensing member is electrically connected with the control member, and the third sensing member is used to detect whether pets enter the roller component 120.

In an example, optionally, referring to FIG. 1 and FIG. 2, the cat litter box 100 further includes a litter adding device 140. One end of the roller component 120, far from the packaging device 130, is provided with a third opening 123. The base 110 is provided with a second mounting groove 113, the litter adding device 140 is inserted into the second mounting groove 113, and the litter adding device 140 extends into the roller component 120 through the third opening 123, so that the litter adding device 140 can add cat litter into the roller component 120 through the third opening 123, and the litter adding device 140 can control the amount of added cat litter, thus realizing the function of automatically replenishing litter, so as to improve the cleanliness and user convenience of the cat litter box 100, and to maintain proper toileting habits for cats.

In all the examples shown and described here, any specific value should be interpreted as illustrative only and not as a limitation, and therefore, other examples of exemplary examples can have different values.

The above-mentioned examples only express several examples of the present disclosure, and the description thereof is relatively specific and detailed, but cannot be understood as a limitation on the present disclosure. It should be noted that, for a person of ordinary skill in the art, several modifications and improvements may be made without departing from the concept of the present disclosure, which all fall within the protection scope of the present disclosure.

1. A cat litter box, comprising:
a base, wherein the base is provided with a first mounting groove and a feces collecting bin, and the feces collecting bin is configured to accommodate a sealing bag therein;
a roller component, wherein the roller component is installed in the first mounting groove, and the roller component rotates relative to the base; a litter-separating member is provided in interior of the roller component, and one side of the roller component close to the feces collecting bin is provided with a first opening; the litter-separating member extends to a position of the first opening; the roller component is communicated with the feces collecting bin through the first opening, and
a packaging device, wherein the packaging device is arranged corresponding to the feces collecting bin; the packaging device comprises a sealing component and a cutting component; the cutting component comprises a heating member and a cutting member, with the heating member attached to the cutting member to heat the cutting member, and the heated cutting member is configured to fuse and seal the sealing bag; and the sealing component moves relative to the cutting member and the sealing component is configured tocan abut against or move away from the cutting member, wherein,
the sealing component comprises a driving member, a movable member and a transmission screw; the driving member is in transmission connection with the transmission screw, and the movable member is movably connected with the transmission screw; and the driving member drives the movable member to move relatively in a first direction through the transmission screw, wherein
the sealing component further comprises a first microswitch and a second microswitch, and the movable member has a first position and a second position, the first microswitch is arranged at the first position, and the second microswitch is arranged at the second position;
when the movable member is at the first position, the movable member abuts against the cutting member, and the movable member abuts against the first microswitch, and
when the movable member is at the second position, the movable member is far away from the cutting member, and the movable member abuts against the second microswitch.

2. (canceled)

3. The cat litter box according to claim 12, wherein the sealing component further comprises a guide rail member, one end of the movable member is movably connected with the transmission screw, and one end of the movable member faces the transmission screw, and the other end opposite to the one end is connected with the guide rail member the guide rail member is arranged in parallel with the transmission screw.

4. (canceled)

5. The cat litter box according to claim 12, wherein the cutting component comprises a box body; the box body is provided with an accommodating groove; the heating member is arranged in the accommodating groove; the cutting member closes a notch of the accommodating groove; and a side of the cutting member facing away from the heating member is provided with a blade part, and the blade part corresponds to the movable member.

6. The cat litter box according to claim 1, wherein the cat litter box further comprises a cover plate member, the feces collecting bin is provided with a second opening, and the cover plate member is configured to cover the second opening; and the cover plate member is movably connected with the feces collecting bin.

7. The cat litter box according to claim 6, wherein a center line direction of the second opening and a center line direction of the first opening are perpendicular to each other.

8. The cat litter box according to claim 6, wherein an air outlet and an aeration member are arranged in the feces collecting bin; and the aeration member is arranged at the air outlet, and the aeration member is configured to create a negative pressure space within the feces collecting bin.

9. The cat litter box according to claim 1, wherein the cat litter box further comprises a control member and a first sensing member; the first sensing member is arranged at a bottom of the feces collecting bin, and the control member is electrically connected with the first sensing member.

10. The cat litter box according to claim 1, wherein the cat litter box further comprises a litter adding device; one end of the roller component faces the packaging device, and the other end opposite to the one end is provided with a third opening, and the base is provided with a second mounting groove; and the litter adding device is inserted into the second mounting groove, and the litter adding device extends into the roller component through the third opening.
